(19) United States
(12) Patent Application Publication
(10) Pub. No.: US 2010/0005991 A1
(43) Pub. Date: Jan. 14, 2010

(54) PRINTING PRODUCT MANUFACTURING METHOD AND PRINTING PRODUCT MANUFACTURING APPARATUS AND PRINTING METHOD

(75) Inventor: Masahiko Yoshida, Shiojiri-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/497,404

(22) Filed: Jul. 2, 2009

(30) Foreign Application Priority Data
Jul. 7, 2008 (JP) 2008-177136

(51) Int. Cl. B41L 3/02

(52) U.S. Cl. 101/486

(57) ABSTRACT

A printing product manufacturing method of printing a plurality of printing products on a medium includes: generating first and second images on the basis of a printing target image; printing the first image in a first area of a print area and printing the second image in a second area of the print area on the downstream side of the first area in a transport direction; and transporting the first image printed in the first area to the second area, wherein the printing products in which the printing target image is printed on the medium are manufactured by alternately repeating the printing and the transporting.

This application claims priority to Japanese Patent Application No. 2008-177136, filed Jul. 7, 2008, the entirety of which is incorporated by reference herein.

### BACKGROUND OF THE INVENTION

1. Field of the Invention

The present invention relates to a printing product manufacturing method and a printing product manufacturing apparatus.

2. Invention of Related Art

As a printing apparatus capable of printing several printing product on a medium with a longitudinal shape, there is known a printing apparatus disclosed in Patent Document 1, for example.

The printing apparatus alternately performs a print operation and a transport operation to print several printing products on a medium. Upon the print operation, a plurality of images is printed in print areas. Upon the transport operation, an area which is not subjected to the print operation is transported outside the print area and an area which is subjected to the print operation is transported to the print area.

Patent Document 1] JP-A-2003-118136

### SUMMARY OF THE INVENTION

When a print operation is performed with high concentration using a liquid (for example, ink) (when dots are formed with high density), an image may spread or a medium may be curled (a phenomenon in which the medium is deformed due to the moisture or the components of the ink). For this reason, the quality of a printing product may deteriorate.

An object of the invention is to improve the quality of a printing product.

### [Means for Solving the Problem]

In order to achieve a main aspect of the invention, there is provided a printing product manufacturing method of printing a plurality of printing products on a medium. The printing product manufacturing method includes: generating first and second images on the basis of a printing target image; printing the first image in a first area of a print area and printing the second image in a second area of the print area on the downstream side of the first area in a transport direction; and transporting the first image printed in the first area to the second area. The printing products in which the printing target image is printed on the medium are manufactured by alternately repeating the printing and the transporting.

Other aspects of the invention are apparent from the description of the specification and the accompanying drawings.

### BRIEF DESCRIPTION OF DRAWINGS

FIG. 1 is a block diagram illustrating the overall configuration of a printer 1.

FIG. 2 is a schematic diagram illustrating the overall configuration of the printer 1.

FIG. 3 is an explanatory diagram illustrating the vicinity of a print area.

FIG. 4 is an explanatory diagram illustrating a printing product according to a first embodiment.

FIG. 5 is an explanatory diagram illustrating image data used for a print operation according to the first embodiment.

FIG. 6 is an explanatory diagram illustrating the structure of two white images according to the first embodiment.

FIG. 7 is an explanatory diagram illustrating a printing method according to the first embodiment.

FIG. 8 is an explanatory diagram illustrating a printing product according to a second embodiment.

FIG. 9 is an explanatory diagram illustrating image data used for a print operation according to the second embodiment.

FIG. 10 is an explanatory diagram illustrating a printing method according to the second embodiment.

FIG. 11 is an explanatory diagram illustrating a printing product according to a third embodiment.

FIG. 12 is an explanatory diagram illustrating image data used for a print operation according to the third embodiment.

FIG. 13 is an explanatory diagram illustrating a printing method according to the third embodiment.

FIG. 14 is an explanatory diagram illustrating a printing product according to a fourth embodiment.

FIG. 15 is an explanatory diagram illustrating image data used for a print operation according to the fourth embodiment.

FIG. 16 is an explanatory diagram illustrating a printing method according to the fourth embodiment.

FIG. 17 is an explanatory diagram according to a modified example of the fourth embodiment.

FIG. 18 is an explanatory diagram illustrating a printing product according to a fifth embodiment.

FIG. 19 is an explanatory diagram illustrating image data used for a print operation according to the fifth embodiment.

FIG. 20 is an explanatory diagram illustrating a printing method according to the fifth embodiment.

FIG. 21 is an explanatory diagram according to a first modified example of the fifth embodiment.

FIG. 22 is an explanatory diagram according to a second modified example of the fifth embodiment.

FIG. 23 is an explanatory diagram illustrating a printing product according to a sixth embodiment.

FIG. 24 is an explanatory diagram illustrating an image according to the sixth embodiment.

FIG. 25 is an explanatory diagram illustrating image data used for a print operation according to the sixth embodiment.

FIG. 26 is an explanatory diagram illustrating a printing method according to the sixth embodiment.

### REFERENCE NUMERALS

1 printer

10 transport unit

11 supply mechanism

12A to 12F transport roller

13 winding mechanism

20 carriage unit

21 carriage

22 guide

30 head unit

31 head

40 heater unit

41 hot platen

42 drying mechanism

50 detector group

51 mark detecting sensor

60 controller

61 interface unit

62 CPU

63 memory

64 unit control circuit

110 computer

### DESCRIPTION OF PREFERRED EMBODIMENT

At least the following aspects of the invention are apparent from the description of the specification and the accompanying drawings.

The present invention provides a printing product manufacturing method of printing a plurality of printing products on a medium. The printing product manufacturing method includes: generating first and second images on the basis of a printing target image; printing the first image in a first area of a print area and printing the second image in a second area of the print area on the downstream side of the first area in a transport direction; and transporting the first image printed in the first area to the second area. The printing products in which the printing target image is printed on the medium are manufactured by alternately repeating the printing and the transporting.

According to the printing product manufacturing method, it is possible to prevent the medium from being curled and prevent an image from spreading. Accordingly, it is possible to improve the quality of the printing products.

In the printing product manufacturing method, it is preferable that the first image and the second image are different from each other. According to the printing product manufacturing method, it is possible to prevent the medium from being curled and prevent an image from spreading. For example, the first image may be an image used to form dots in certain pixels of the printing target image and the second image may be an image used to form dots in another pixels of the printing target image. In this case, by dividing the printing target image into a plurality of images which stand in a complementary relation, the amount of liquid consumed upon printing each image can be reduced. Alternatively, the first image may be an image used to form dots of a certain color of the printing target image and the second image may be an image used to form dots of another color of the printing target image. In this case, by dividing the printing target image into images of each color, the amount of liquid consumed upon printing each image can be reduced.

In the printing product manufacturing method, the printing target image may be a background image and an image used to view the background image as a background and the printing target image may be printed in an overlapping manner.

According to the printing product manufacturing method, an image against the background can be readily viewed due to the background image.

In the printing product manufacturing method, one of the first image and the second image may be a background image and the other of the first image and the second image may be an image used to view the background image as a background.

According to the printing product manufacturing method, by dividing the printing target image into the background and a portion other than the background, the amount of liquid consumed upon printing each image can be reduced.

In the printing product manufacturing method, when the image used to view the background image as the background is printed in a third area different from the first and second areas upon printing the first image in the first area and upon printing the second image in the second area, it is preferable that a gap between the first and second areas is narrower than a narrower one of a gap between the first and third areas and a gap between the second and third areas.

According to the printing product manufacturing method, it is possible to more reliably prevent the image from spreading.

In the printing product manufacturing method, it is preferable that in certain transporting, the first image is transported from the first area to an area between the first and second areas and in the subsequent transporting, the first image is transported from the area between the first and second areas to the second area.

According to the printing product manufacturing method, the period in which the first image is printed and then the second image is printed thereon can be set longer. Accordingly, it is possible to prevent the image from spreading.

The present invention provides a printing product manufacturing apparatus which prints a plurality of printing products on a medium includes: a unit which generates first and second images on the basis of a printing target image; a unit which prints the first image in a first area of a print area and prints the second image in a second area of the print area on the downstream side of the first area in a transport direction; and a unit which transports the first image printed in the first area to the second area. The printing products in which the printing target image is printed on the medium are manufactured by alternately repeating the printing and the transporting.

According to the printing product manufacturing apparatus, it is possible to prevent the medium from being curled and prevent an image from spreading. Accordingly, it is possible to improve the quality of the printing products.

The present invention provides a printing product printing method of printing a plurality of printing products on a medium. The printing product printing method includes: generating first and second images on the basis of a printing target image; printing the first image in a first area of a print area and printing the second image in a second area of the print area on the downstream side of the first area in a transport direction; and transporting the first image printed in the first area to the second area. The printing products in which the printing target image is printed on the medium are manufactured by alternately repeating the printing and the transporting.

According to the printing product manufacturing method, it is possible to prevent the medium from being curled and prevent an image from spreading. Accordingly, it is possible to improve the quality of the printing products.

Hereinafter, embodiments of the invention will be described using one printer which is a printing apparatus.

### Configuration of Printer

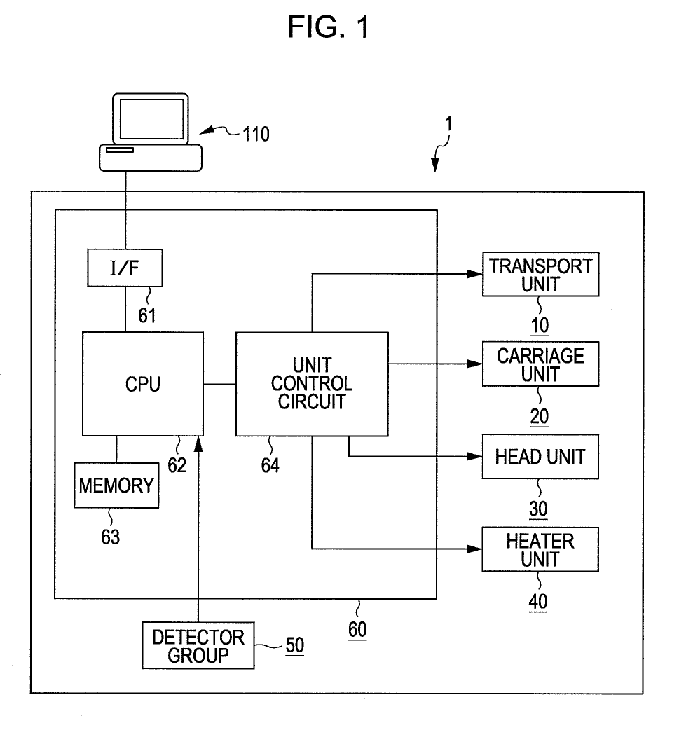

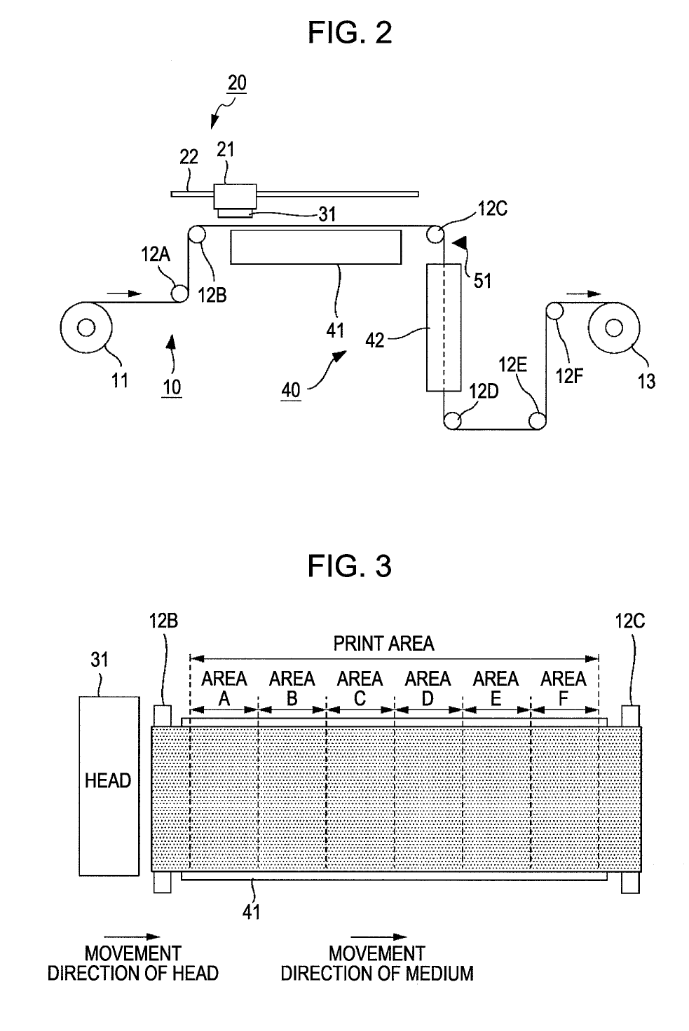

FIG. 1 is a block diagram illustrating the overall configuration of a printer 1. FIG. 2 is a schematic diagram illustrating the overall configuration of the printer 1. FIG. 3 is an explanatory diagram illustrating the vicinity of print area. Hereinafter, the basic configuration of the printer according to the embodiments will be described.

The printer 1 includes a transport unit 10, a carriage unit 20, a head unit 30, a heater unit 40, a detector group 50, and a controller 60. The printer 1 receiving print data from a computer 110, which is an external apparatus, permits the controller 60 to control the respective units (the transport unit 10, the carriage unit 20, the head unit 30, and the heater unit 40). The controller 60 prints images on a medium by controlling the respective units on the basis of the print data received from the computer 1 10. The status of the printer 1 is detected by the detector group 50. The detector group 50 outputs the detected result to the controller 60. The controller 60 controls the respective units on the basis of the detected result output from the detector group 50.

The transport unit 10 transports a roll-shaped medium (for example, a roll sheet or a roll-shaped seal sheet) in a predetermined direction (hereinafter, also referred to as a transport direction). The transport unit 10 includes a supply mechanism 11, transport rollers 12A to 12F, and a winding mechanism 13. The transport rollers 12A and 12B transport the medium supplied from the supply mechanism 11 to the print area and transport the medium subjected to a print operation in the print area to the winding mechanism 13. The controller 60 controls a transport motor (not shown) to adjust the rotation of the transport rollers 12A to 12F and thus control the transport of the medium.

The carriage unit 20 moves a head in a movement direction and includes a carriage 21 for moving a predetermined direction (the movement direction) and a guide 22 for guiding the carriage 21 to the movement direction. The controller 60 controls a carriage motor (not shown) to adjust the movement of the carriage 21. In the printer according to the embodiments, the movement direction of the carriage 21 is the same as the transport direction of the medium transported by the transport unit 10.

The head unit 30 includes a head 31 for ejecting ink onto a medium. The head 31 is mounted on the carriage 21. Therefore, when the carriage 21 moves in the movement direction, the head 31 also moves in the movement direction. Nozzle rows are formed on the lower surface of the head 31 in a medium width direction. The nozzle rows are formed across the length corresponding to the width of the medium. When the head 31 ejects the ink during the movement in the movement direction, images are printed on the print area of the medium.

Even though not shown, the nozzle rows ejecting the color ink such as cyan (C), magenta (M), yellow (Y), and black (K) are formed on the lower surface of the head 31. The nozzle row ejecting white ink, the nozzle row ejecting a fixative, the nozzle row ejecting a coating agent, and the like are also formed on the lower surface of the head 31. The respective ink or the ejected agent may include a UV curing agent.

The heater unit 40 includes a hot platen 41 (corresponding to a drying unit) and a drying mechanism 42. The hot platen 41 holds the medium in the print area and has a heater therein. Therefore, by heating the medium in the print area, the hot platen accelerates the dryness of the image printed in the print area. The drying mechanism 42 is disposed on the downstream side of the print area. By heating the medium printed in the print area, the drying mechanism accelerates the dryness of a printing product outside the print area. The maximum heating range of the drying mechanism 42 is broader than a range corresponding to the print area. In this case, the heating range of the dryness mechanism 42 can be changed by the controller 60. For example, the printing product can be heated in only a range corresponding to two areas (for example, areas A and B in FIG. 3). The power consumption of the drying mechanism 42 is smaller in a case of heating only a range corresponding to two areas than in a case of heating a range corresponding to the print areas (six areas in FIG. 3).

The hot platen 41 and the drying mechanism 42 may be any as long as they are a device capable of drying a print image on a medium or a printing product. For example, a device capable of applying electromagnetic waves such as warm air, infrared light, UV, or microwave onto a medium can be used.

The detector group 50 includes a mark detecting sensor 51, for example. The mark detecting sensor 51 is used to detect the mark printed on the medium. The transport distance of the medium performed by the transport unit 10 is controlled on the basis of the detection result. The detector group 50 also includes an encoder for detecting the rotation degree of the transport rollers 12A to 12F or a linear encoder for detecting the position of the carriage 21 in the movement direction.

The controller 60 is a control unit (controller) which controls the printer. The controller 60 includes an interface unit 61, a CPU 62, a memory 63, and a unit control circuit 64. The interface unit 61 transmits and receives data between the computer 110, which is an external apparatus, and the printer 1. The CPU 62 is an arithmetic processing unit which controls the printer as a whole. The memory 63 guarantees an area where programs of the CPU 62 are stored, a working area, or the like. Image data, which is a printing target, is stored in the memory 63. The CPU 62 controls the respective units through the unit control circuit 64 in accordance with each program stored in the memory 63 and performs a print operation, which is described below. The CPU 62 permits printing an image represented by the image data by ejecting ink or the like from nozzles (not shown) of the head 31 in accordance with the image data stored in the memory 63.

When the print operation is performed, the printer 1 prints a printing product on the medium at the same interval by alternately performing a transport operation of transporting the medium in the transport direction by the transport unit 10 and a print operation of ejecting the ink from the head 31 on the basis of the image data and printing an image on the medium while the carriage unit 20 moves the head 31. As described below, a plurality of images are printed in an overlapping manner.

In the following description, it is assumed that the print area is divided into six areas and an image is printed in each area. The six areas are referred to as an area A, an area B, an area C, an area D, an area E, and an area F in order from the area on the upstream side in the transport direction (see FIG. 3).

The number of the print area divided is not limited to six. The range of the print area is varied depending on the size of the printing product and is not necessarily the maximum printable range (a movable range of the carriage 21) of the printer 1.

### First Embodiment

### Printing Product According to First Embodiment

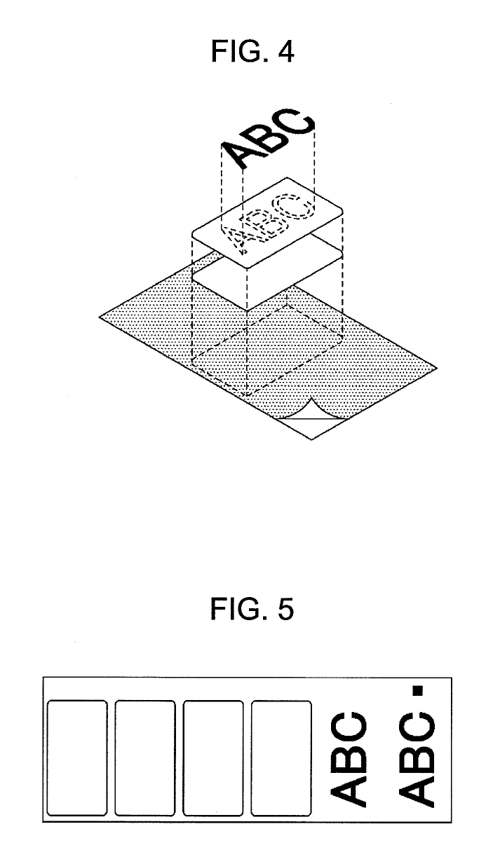

FIG. 4 is an explanatory diagram illustrating a printing product according to a first embodiment.

A medium is constituted by a seal member in which one side is a printing surface and the other side is an adhesive surface and a peeling member covering the adhesive surface of the seal member. The seal member is formed of a transparent film. In this case, the seal member is not necessarily transparent but may be translucent or opaque. The medium may not be a seal sheet, but may be a transparent film having no adhesive surface, or a sheet.

The printing product is obtained by printing three images on the medium in the overlapping manner. An image printed initially on the medium is a rectangular image (hereinafter, referred to as “a white image”) formed by applying white ink. An image printed on a first-layered white image is a second-layered white image. An image printed on the second-layered white image is a character image “ABC” (hereinafter, referred to as “an image ABC”). In other words, the printing product is obtained by forming the two layered white images and the image ABC on the medium in the overlapping manner.

### Image Data Generating Method According to First Embodiment

FIG. 5 is an explanatory diagram illustrating the image data used to perform the print operation according to the first embodiment. As shown in the drawing, the image data contains four white images to be printed in the areas A to D and two images ABC to be printed in the areas E and F. The white image to be printed in the areas A and B is the first-layered white image and the white image to be printed in the areas C and D is the second-layered white image. The first-layered white image and the second-layered white image are different from each other in the dot formed positions, as described below. The image data also contains a mark used to print an image in the area F.

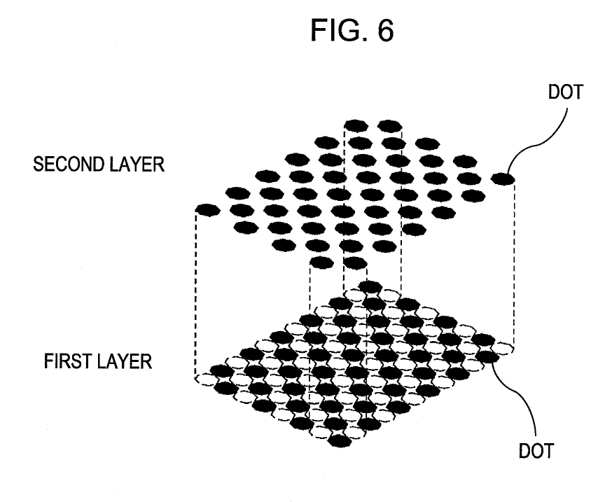

FIG. 6 is an explanatory diagram illustrating two kinds of white images according to the first embodiment. In the drawing, black circles indicate white ink dots. As known from the drawing, the dots are not formed in all pixels by white ink (the white image is not a so-called solid image), but the dots are formed in a checked pattern. The two kinds of white images (the first-layered white image and the second-layered white image) of the image data are set such that the dots of the other white image are formed in the pixels where the dots of one white image are not formed.

For example, the CPU 62 of the printer 1 calculates the total number of dots (hereinafter, referred to as the total number of dots) necessary to print a printing target image. When the total number of dots is larger than a threshold value, the printing target image is divided into two kinds of checked images, as shown in FIG. 6. In the first embodiment, the white images (the solid images) and the image ABC are printed in the overlapping manner. Accordingly, the printing target images are the white images (the solid images) and the image ABC. In this case, since the total number of dots of the white image, which is the solid image, is larger than the threshold value, the CPU 62 divides this white image into two kinds of checked images (generates two kinds of white images). On the other hand, since the total number of dots of the image ABC is equal to or less than the threshold value, the image ABC is arranged in the image data without change. Then, the CPU 62 generates the image data where the images are arranged as in FIG. 5 and stores the image data in the memory 63.

### Printing Method According to First Embodiment

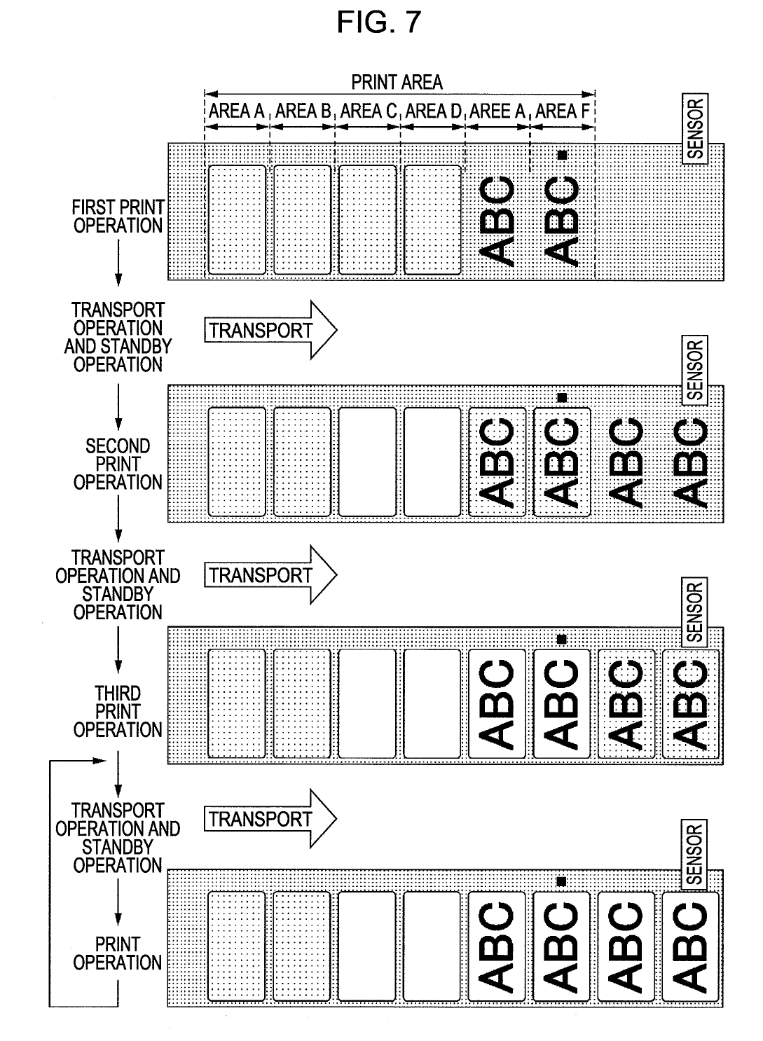

FIG. 7 is an explanatory diagram illustrating a printing method according to the first embodiment. In the first embodiment, as described below, the printer alternately repeats the print operation performed on the basis of the image data in FIG. 5 and the transport operation of transporting the medium by a transport distance corresponding to the length of two printing products.

First, upon a first print operation, the printer 1 prints the first-layered white image in each of the areas A and B and prints the second-layered white image in each of the areas C and D on the downstream side of the areas A and B in the transport direction, while moving the head 31 in the movement direction. The printer prints the image ABC in each of the areas E and F on the downstream side of the areas C and D in the transport direction. Upon the first print operation, the mark is printed in the area F.

After the first print operation, the printer 1 transports the medium by the transport distance corresponding to the length of two printing products (the transport operation). When the medium is transported upon the first print operation described above until a sensor detects the mark printed in the area F, the transport operation is performed by the transport distance corresponding to the length of the two printing products. During the transport operation, a standby operation of drying the white images or the image ABC is also performed. Upon the transport operation, the medium on which no image is printed is transported to the areas A and B, the first-layered white image printed in the areas A and B upon the first print operation are transported to the areas C and D, and then the second-layered white image printed in the areas C and D upon the first print operation are transported to the areas E and F.

Like the first print operation, upon a second print operation, the printer 1 also prints the first-layered white image in the areas A and B, prints the second-layered white image in the areas C and D, and then prints the image ABC in the areas E and F. In this case, in the second print operation, the first-layered white image printed in the first print operation are formed in the areas C and D and the second-layered white image printed in the first print operation are formed in the areas E and F. Accordingly, upon the second print operation, the second-layered white image is printed on the first layered white image in the areas C and D and the image ABC is printed on the second-layered white image in the areas E and F.

After the second print operation, the printer 1 transports the medium by the transport distance corresponding to the length of two printing products (the transport operation). Upon the transport operation, the medium on which no image is printed is transported to the areas A and B, the first-layered white image printed in the areas A and B upon the second print operation are transported to the areas C and D, and then the second-layered white image printed in the areas C and D upon the second print operation are transported to the areas E and F.

Like the first and second print operations, upon a third print operation, the printer 1 also prints the first-layered white image in the areas A and B, prints the second-layered white image in the areas C and D, and then prints the image ABC in the areas E and F. In this case, in the third print operation, one layered (first-layered) white image is formed in the areas C and D and two layered (first and second-layered) white images are formed in the areas E and F. Accordingly, upon the third print operation, the second-layered white image is printed in each of the areas C and D and two printing products are completed in the areas E and F.

After the third print operation, the printing products are printed at the same interval on the medium by alternately repeating the same transport operation and the same print operation. In the print operation after the third print operation, the first-layered white image is printed in the areas A and B, the second-layered white image is printed each of the areas C and D, and two printing products are completed in the areas E and F. In addition, in the transport operation after the third print operation, the medium on which no image is printed is transported to the areas A and B, the white images printed in the areas A and B in the immediately previous print operation are transported to the areas C and D, the second-layered white image is printed each of the areas C and D upon the immediately previous print operation are transported to the areas E and F.

According to the first embodiment, two printing products are completed in every print operation.

### <Advantage Obtained by Using Two Kinds of White Images>

If a white image is formed in all the pixels (as a solid image), the amount of ink used in a one-time print operation may be increased, thereby causing the medium to be curled. Moreover, since it is difficult to dry the medium due to a considerable amount of ink, the image ABC printed on the white images may spread.

In this embodiment, however, as shown in FIG. 6, the white image (the first-layered white image) printed in the areas A and B and the white image (the second-layered white image) printed in the areas C and D are not formed as a solid image, but are formed by the dots with the checked patterns which stand in a complementary relation. In addition, the dots of the other white image are formed in the pixels where the dots are not formed in one white image. That is, in this embodiment, the amount of white ink ejected from the head upon printing each white image can be reduced. In this way, it is possible to prevent the medium from being curled. Moreover, since the amount of ink used upon printing each white image is reduced, it is possible to accelerate the dryness of the printing products upon the transport operation by the hot platen 41. In this way, it is possible to prevent the image ABC printed on the white images from spreading.

In this embodiment, by forming the dots in certain pixels of the printing target image (in this case, the solid white image) by one white image, the dots are set so as to be formed in other pixels of the printing target image by the other white image. The original white image (the solid image) is printed by printing the images in the overlapping manner. In this way, since the medium is prevented from being curled or an image is prevented from spreading in comparison to the case of forming the dots in the pixels by a one-time print operation, it is possible to improve the quality of the printing product.

In the first embodiment, the three images (the two kinds of white images and the image ABC) printed on the medium are all contained in the same image data. That is, one kind of image data may be stored in the memory 63 of the printer 1. Accordingly, the capacity used to store the image data can be reduced, compared to the case of dividing and using the image data for every kind of images.

In this embodiment, since the standby operation is performed during the transport operation, the dryness of the images printed in the immediately previous print operations is also accelerated by the hot platen 41. Accordingly, it is possible to shorten the print period.

In this embodiment, the printing target image (the white image) is divided into the images having the two kinds of checked patterns by thinning the printing target image in pixel unit, and the two images different from each other in the pixel positions at which the dots are formed are set. However, the image dividing method is not limited to the method of dividing the printing target image into the images with the checked patterns, as long as the printing target image may be divided into two images. The printing target image is not limited to the white image, but may be a different colored image, for example. Alternatively, the printing target image may be an image which is printed using plural kinds of ink. In this case, the two divided images may be each an image printed using plural kinds of ink and an image printed using one kind of ink. Alternatively, the printing target image may be divided into three or more kinds of images and the images may be printed in the overlapping manner. The printing target image may be an image formed by printing information such as a character or a picture as well as the rectangular image.

### Second Embodiment

### Printing Product According to Second Embodiment

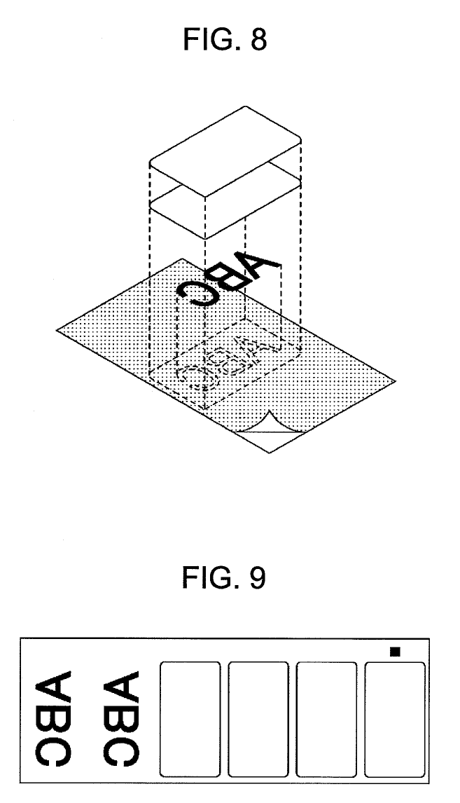

FIG. 8 is an explanatory diagram illustrating a printing product according to a second embodiment. Compared to the printing product according to the first embodiment, the order of the white images and the image ABC is different. Accordingly, the image ABC becomes a mirror image.

A medium is constituted by a seal member in which one side is a printing surface and the other side is an adhesive surface and a peeling member covering the adhesive surface of the seal member. The seal member is formed of a transparent film. In this case, the seal member is not necessarily transparent but may be translucent or opaque. The medium may not be a seal sheet, but may be a transparent film having no adhesive surface.

The printing product is obtained by printing three images on the medium in the overlapping manner. An image printed initially on the medium is an image (hereinafter, referred to as “a mirror image ABC”) formed by mirroring an image of characters “ABC”. The images printed on the mirror image ABC are two white images. In other words, the printing product is obtained by forming first-layered mirror images ABC, second-layered white images, and third-layered white images in the overlapping manner. As in the first embodiment, in the white images according to the second embodiment, the white image of each layer is not formed by forming dots in all the pixels (the white image is not formed as a so-called solid image), but the dots are formed in a checked pattern. Two white images of the image data are set such that the dots of the other white image are formed in the pixels where the dots of one white image are not formed.

When the peeling member of the printing product is detached and the adhesive surface of the seal member is attached on a window indoors, for example, the characters “ABC” can be viewed outdoors over the seal member (the characters “ABC” can be viewed from a side opposite to the printing surface of the seal member). When the printing produce is used in this manner, the seal member is made so as to be transparent or translucent and the first-layered image is formed as a mirror image.

### Image Data Generating Method According to Second Embodiment

FIG. 9 is an explanatory diagram illustrating the image data used for the print operation according to the second embodiment. As shown in the drawing, the image data contains two mirror images ABC to be printed in the areas A and B and four white images to be printed in the areas C to F. The white images printed in the areas C and D are second-layered white images. The white images printed in the areas E and F are third-layered white images. The image data contains a mark to be printed in the area F.

As in the first embodiment, in the second embodiment, the CPU 62 of the printer 1 also calculates the total number of dots of a printing target image. When the total number of dots is larger than a threshold value, the printing target image is divided into two kinds of checked images. In the second embodiment, the printing target image is the white images (the slid images) and the mirror images ABC. In this case, since the total number of dots of the white image, which is the solid image, is larger than the threshold value, the CPU 62 divides this white image into two kinds of checked images (generates two kinds of white images). On the other hand, since the total number of dots of the mirror image ABC is equal to or less than the threshold value, the mirror image ABC is arranged in the image data without change. Then, the CPU 62 generates the image data where the images are arranged as in FIG. 9 and stores the image data in the memory 63.

### Printing Method According to Second Embodiment

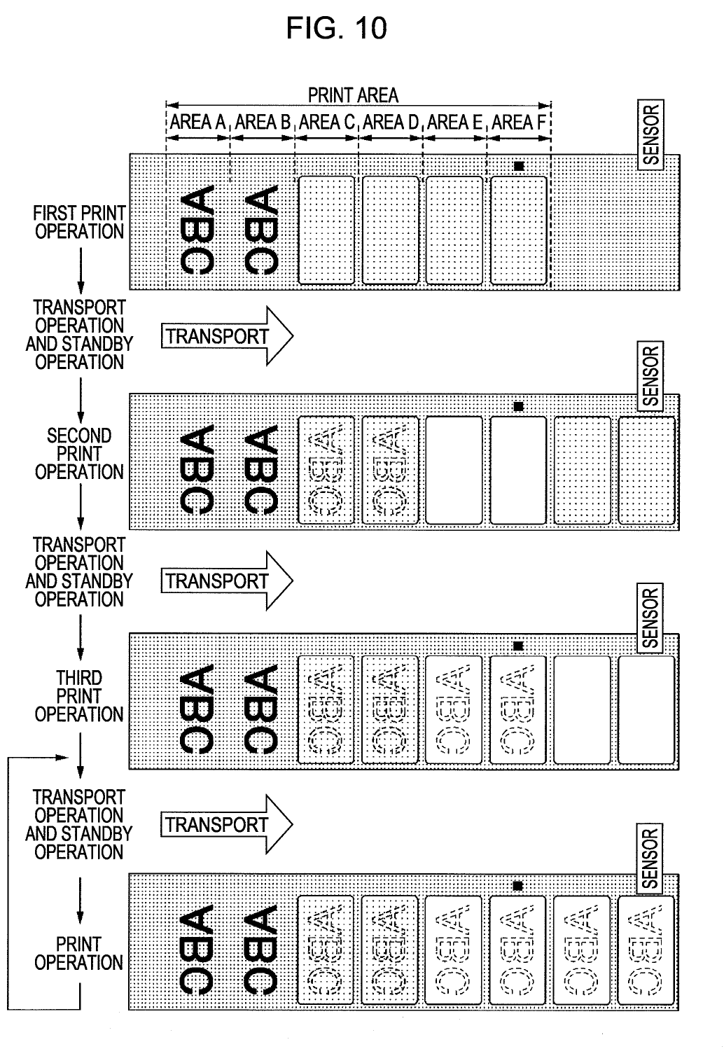

FIG. 10 is an explanatory diagram illustrating a printing method according to the second embodiment. In the second embodiment, as described below, the printer alternately repeats the print operation performed on the basis of the image data in FIG. 9 and the transport operation of transporting the medium by a transport distance corresponding to the length of two printing products.

First, upon a first print operation, the printer 1 prints the mirror images ABC in the areas A and B and prints the white images (the second-layered white images) in the areas C and D on the downstream side of the areas A and B in the transport direction, while moving the head 31 in the movement direction. The printer prints the white images (the third-layered white images) in each of the areas E and F on the downstream side of the areas C and D in the transport direction. Upon the first print operation, the mark is printed in the area F.

After the first print operation, the printer 1 transports the medium by the transport distance corresponding to the length of two printing products (the transport operation). When the medium is transported upon the first print operation described above until a sensor detects the mark printed in the area F, the transport operation is performed by the transport distance corresponding to the length of the two printing products. During the transport operation, a standby operation of drying the white images or the mirror images ABC printed in the first print operation is also performed. Upon the transport operation, the medium on which no image is printed is transported to the areas A and B, the mirror images ABC printed in the areas A and B upon the first print operation are transported to the areas C and D, and then the white images (the second-layered white images) printed in the areas C and D upon the first print operation are transported to the areas E and F.

Like the first print operation, upon a second print operation, the printer 1 also prints the mirror images ABC in the areas A and B, prints the white images (the second-layered white images) in the areas C and D, and then prints the white images (the third white images) in the areas E and F. In this case, in the second print operation, the mirror images ABC printed in the first print operation are formed in the areas C and D. Accordingly, upon the second print operation, the second-layered white images are printed on the mirror images ABC in the areas C and D and the third-layered white images are printed on the second-layered white images in the areas E and F.

After the second print operation, the printer 1 transports the medium by the transport distance corresponding to the length of two printing products (the transport operation). Upon the transport operation, the medium on which no image is printed is transported to the areas A and B, the mirror images ABC printed in the areas A and B upon the second print operation are transported to the areas C and D, and then the white images printed in the areas C and D upon the second print operation are transported to the areas E and F.

Like the first and second print operations, upon a third print operation, the printer 1 also prints the mirror images ABC in the areas A and B, prints the white images (the second-layered white images) in the areas C and D, and then prints the white images (the third-layered white images) in the areas E and F. In this case, in the third print operation, the mirror images ABC are formed in the areas C and D and the white images (the second-layered white images) printed in the mirror images ABC are formed in the areas E and F. Accordingly, upon the third print operation, the white images are printed on the mirror images ABC in the areas C and D and two printing products are completed in the areas E and F.

After the third print operation, the printing products are printed at the same interval on the medium by alternately repeating the same transport operation and the same print operation. In the print operation after the third print operation, the mirror images ABC are printed in the areas A and B, the white images (the second-layered white images) are printed on the mirror images ABC in the areas C and D, and two printing products are completed in the areas E and F. In addition, in the print operation after the third print operation, the medium on which no image is printed is transported to the areas A and B, the mirror images ABC printed in the areas A and B in the immediately previous print operation are transported to the areas C and D, the white images (the second-layered white images) printed on the mirror images ABC upon the immediately previous print operation are transported to the areas E and F.

According to the second embodiment, two printing products are completed in every print operation. According to the second embodiment, other printing products can be printed, while the same advantages as those of the first embodiment are obtained.

### Third Embodiment

### Printing Product According to Third Embodiment

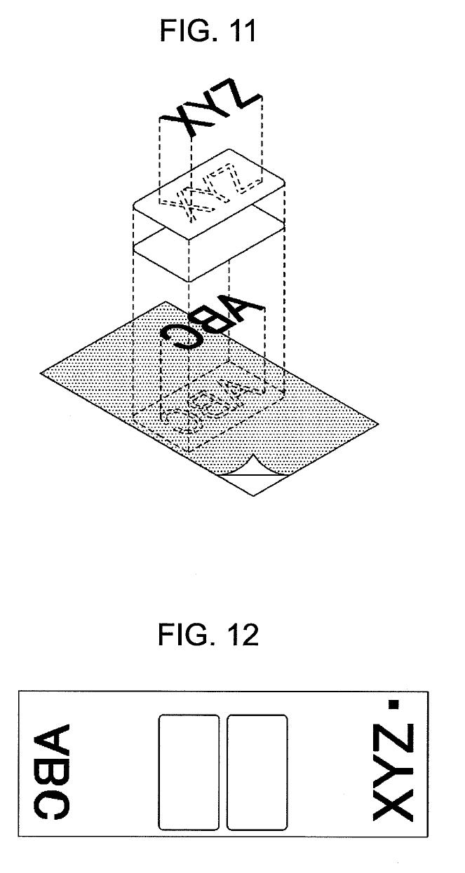

FIG. 11 is an explanatory diagram illustrating a printing product according to a third embodiment. Compared to the second embodiment, a character image (XYZ) different form the mirror image ABC is formed on the white image.

A medium is constituted by a seal member in which one side is a printing surface and the other side is an adhesive surface and a peeling member covering the adhesive surface of the seal member. The seal member is formed of a transparent film. In this case, the seal member is not necessarily transparent but may be translucent. The medium may not be a seal sheet, but may be a transparent film having no adhesive surface.

The printing product is obtained by printing four images on the medium in the overlapping manner. An image printed initially on the medium is a mirror image ABC. Two white images are printed on the mirror image ABC. An image printed on the white images is a character image of “XYZ” (hereinafter, referred to as “an image XYZ”). In other words, the printing product is obtained by forming a first-layered mirror image ABC, second and third-layered white images, and a fourth-layered image XYZ in the overlapping manner.

When the peeling member of the printing product is detached and the adhesive surface of the seal member is attached on a window indoors, for example, the characters “XYZ” can be viewed indoors and the characters “ABC” can be viewed outdoors over the seal member (the characters “ABC” can be viewed from a side opposite to the printing surface of the seal member). The images of the printing product can be viewed from both sides. When the printing product is used in this manner, the seal member is made so as to be transparent or translucent and the first-layered image is formed as a mirror image.

### Image Data Generating Method According to Third Embodiment

FIG. 12 is an explanatory diagram illustrating the image data used for the print operation according to the third embodiment. As shown in the drawing, the image data contains the mirror image ABC to be printed in the area A, two white images to be printed in the areas C and D, and the image XYZ to be printed in the area F. The white image printed in the area C is a second-layered white image. The white image printed in the area D is a third-layered white image. The image data contains a mark to be printed in the area F.

In the third embodiment, the two kinds (the second and third layers) of white images of the image data are set such that dots of a checked pattern in one white image (for example, the white image printed in the area C) are formed and dots of the other white image (for example, the white image printed in the area D) are formed in a checked pattern in pixels where the dots are not formed.

As in the first embodiment, in the third embodiment, the CPU 62 of the printer 1 also calculates the total number of dots of a printing target image. When the total number of dots is larger than a threshold value, the printing target image is divided into two kinds of checked images. In the third embodiment, the printing target image is the white images (the solid images), the mirror image ABC, and the image XYZ. In this case, since the total number of dots of the white image, which is the solid image, is larger than the threshold value, the CPU 62 divides this white image into two kinds of checked images (generates two kinds of white images). On the other hand, since the total number of dots of the mirror image ABC or the image XYZ is equal to or less than the threshold value, they are arranged in the image data without change.

In this embodiment, since the print areas are six areas A to F, four images are arranged in the six areas in order of the mirror image ABC, the two kinds of white images, and the image XYZ. In this case, as shown in FIG. 12, it is preferable that a gap between the two white images is made narrower and a gap between the mirror image ABC and the white image, and a gap between the image XYZ and the white image are made broader. In this way, since the period in which the white images are printed after the printing of the mirror image ABC can be set so as to be long, it is possible to prevent the mirror image ABC from spreading. Moreover, since the period in which the image XYZ is printed after the printing of the white images can be set so as to be long, it is possible to prevent the image XYZ from spreading. Even though the period in which the next white image is printed after the printing of the initial white image is short, the white image does not spread, as described below.

The CPU 62 stores the image data where the images are arranged as in FIG. 12 in the memory 63.

### Printing Method According to Third Embodiment

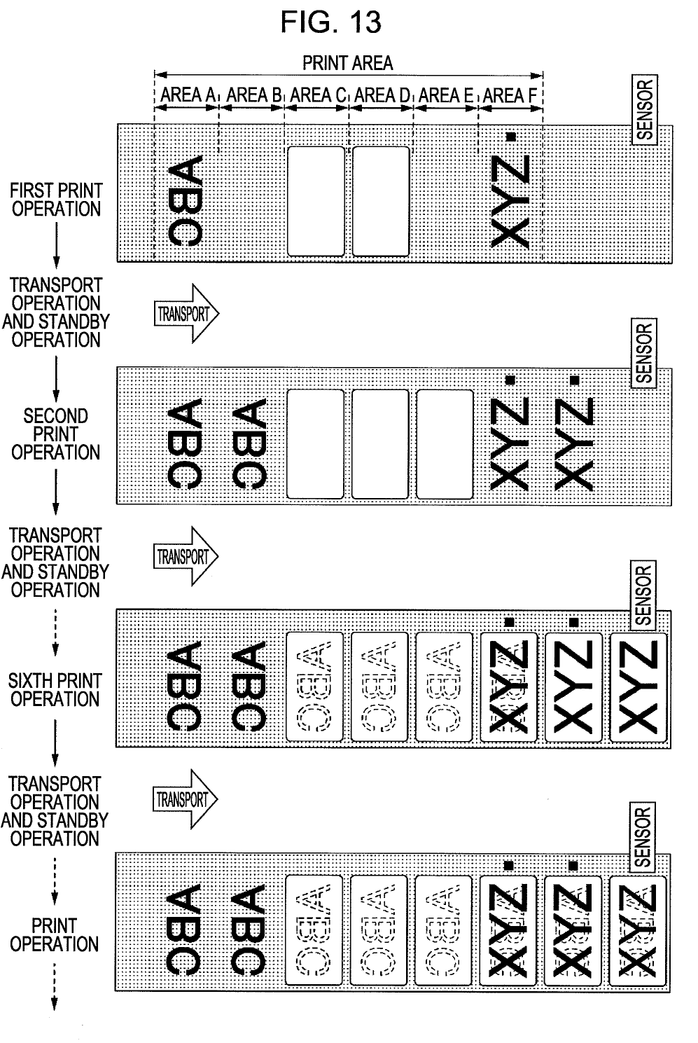

FIG. 13 is an explanatory diagram illustrating a printing method according to the third embodiment. In the third embodiment, as described below, the printer alternately repeats the print operation performed on the basis of the image data in FIG. 12 and the transport operation of transporting the medium by a transport distance corresponding to the length of one printing product.

First, upon a first print operation, the printer 1 prints the mirror image ABC in the area A, prints the (second-layered) white image in the area C on the downstream side of the area A in the transport direction, prints the (third-layered) white image in the area D on the downstream side of the area C in the transport direction, and prints the image XYZ in the area F on the downstream side of the area D in the transport direction, while moving the head 31 in the movement direction. In the first print operation, a mark is printed in the area F.

After the first print operation, the printer 1 transports the medium by the transport distance corresponding to the length of one printing product (the transport operation). During the transport operation, a standby operation of drying the mirror image ABC or white images is also performed. Upon the transport operation, the medium on which no image is printed is transported to the area A, the mirror image ABC printed in the area A upon the first print operation is transported to the area B, and then the white images printed in the areas C and D upon the first print operation are transported to the vicinity on the downstream side in the transport direction.

Like the first print operation, upon a second print operation, the printer 1 also prints the mirror image ABC in the area A, prints the white images in the areas C and D, and then prints the image XYZ in the area F. After the second print operation, the printer 1 alternately repeats the same transport operation and the same print operation.

In the print operation after the sixth print operation, the printer 1 also prints the mirror image ABC in the area A, like the first print operation, prints the second-layered white image in the area C, prints the third-layered white image in the area D, and then prints the image XYZ in the area F. In this case, in the print operation after the sixth print operation, the mirror image ABC is formed in the area C, one-layered white image (the second-layered white image) printed on the mirror image ABC is formed in the area D, and two-layered white images (the second and third-layered white images) printed on the mirror image ABC are formed in the area F. Accordingly, in the print operation after the fifth print operation, an initial layered white image (the second-layered white image) is printed on the mirror image ABC in the area C, a second successive layered white images (the third-layered white image) is printed on the mirror image ABC in the area D, and one printing product is completed in the area F.

In the third embodiment, one printing product is completed in every print operation.

In the third embodiment, the period in which the initial white image is printed and a subsequent white image is printed is shorter than the period in which the mirror image ABC is printed and then the white image is printed or than the period in which the white image is printed and then the image XYZ is printed. In this case, the dots of the subsequent (the third-layered) white image are formed in the pixels where the dots of the initial (the second-layered) white image are not formed. Therefore, even though a drying period becomes shorter, the problem with the spreading does not arise. If the dots of the initial white image and the dots of the subsequent white image spread to each other, the same color is just mixed. Therefore, there is no influence on the image quality. In other words, in the third embodiment, the second successive white image (the third-layered white image) can be printed immediately after the initial layered white image (the second-layered white image). Therefore, the period in which the second-layered white image is printed and then the image XYZ is printed can be set to be short.

The white images printed in the areas C and D are not formed as a solid image, but are formed by the dots with the checked patterns which stand in a complementary relation. Accordingly, the amount of white ink ejected from the head upon printing the white images in the areas C and D can be reduced. In this way, when the white image is printed in the area C, the beginning image (here, the mirror image ABC) can hardly spread. Therefore, when the characters XYZ are printed in the area F, the image XYZ can hardly spread. Moreover, it is possible to prevent the medium from being curled. Therefore, the quality of the printing product can be improved.

The transport distance in the transport operation according to the third embodiment is shorter than the transport distance in the transport operation according to the first embodiment or the second embodiment. Therefore, in the third embodiment, since the drying mechanism 42 can just heat the medium in the range corresponding to one area (for example, the area A), power consumption can be reduced.

### Fourth Embodiment

### Printing Product According to Fourth Embodiment

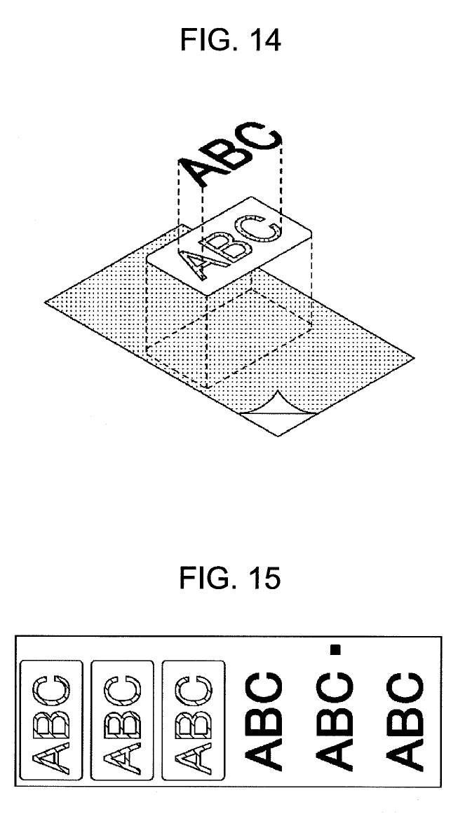

FIG. 14 is an explanatory diagram illustrating a printing product according to a fourth embodiment. The number of layers of the white images is different from that of the first embodiment. As described below, data regarding the white image is also different.

A medium is constituted by a seal member in which one side is a printing surface and the other side is an adhesive surface and a peeling member covering the adhesive surface of the seal member. The seal member is formed of a transparent film. In this case, the seal member is not necessarily transparent but may be translucent or opaque. The medium may not be a seal sheet, but may be a transparent film having no adhesive surface, or a sheet.

The printing product is obtained by printing two images on the medium in the overlapping manner. An image initially printed on the medium is a white image. An image printed on the white image is an image ABC. In other words, the printing product is obtained by forming a first-layered white image and a second-layered image ABC on the medium in an overlapping manner. In this case, in the white image according to the fourth embodiment, dots are formed in pixels other than the pixels where characters in the image ABC are formed (hereinafter, referred to as “thinned white image). That is, the thinned white image and the image ABC stand in a complementary relation. In other words, the dots of the image ABC are formed in the pixels where the white ink dots of the thinned white image are not formed.

### Image data Generating Method According to Fourth Embodiment

FIG. 15 is an explanatory diagram illustrating the image data used to perform the print operation according to the fourth embodiment. In the print operations according to the fourth embodiment, the image data contains three thinned white images to be printed in the areas A to C and three images ABC to be printed in the areas D to F. The image data also contains a mark used to print an image in the area E.

In the fourth embodiment, the CPU 62 of the printer 1 divides a printing target image in accordance with each color pattern, when the total number of dots of the printing target image is larger than a threshold value. In the fourth embodiment, the printing target image is an image surrounding the characters ABC in a white background. That is, the printing target image has a white color (the background) and a color (the characters ABC) other than a white color. Accordingly, the CPU 62 divides the printing target image into an image (the thinned white image) of the white background and an image (the image ABC) of the characters ABC. Moreover, the CPU 62 generates the image data in which the images are arranged as in FIG. 15 and stores the image data in the memory 63.

### Printing Method According to Fourth Embodiment

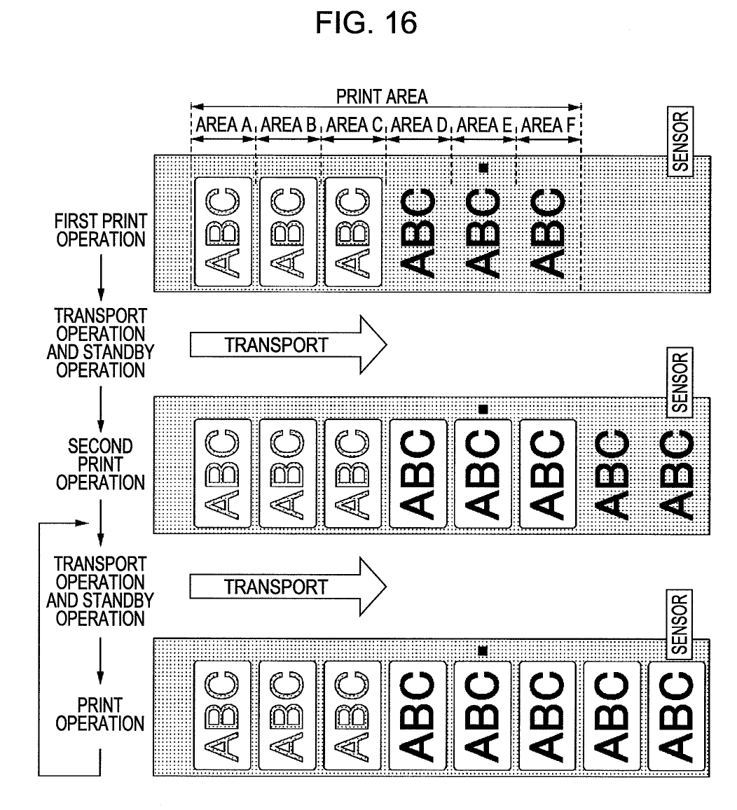

FIG. 16 is an explanatory diagram illustrating a printing method according to the fourth embodiment. In the fourth embodiment, as described below, the printer 1 repeats the print operation of printing the thinned white image in the areas A to C and printing the image ABC in the areas D to F on the basis of the image data in FIG. 15 and the transport operation of transporting the medium by a transport distance corresponding to the length of three printing products.

First, upon a first print operation, the printer 1 prints the thinned white image in each of the areas A to C and prints the image ABC in each of the areas D to F on the downstream side of the areas A to C in the transport direction, while moving the head 31 in the movement direction. Upon the first print operation, the mark is printed in the area E.

After the first print operation, the printer 1 transports the medium by the transport distance corresponding to the length of three printing products (the transport operation). When the medium is transported upon the first print operation described above until a sensor detects the mark printed in the area E, the transport operation is performed by the transport distance corresponding to the length of the three printing products. During the transport operation, a standby operation of drying the thinned white images is also performed. The drying period of the thinned white image according to this embodiment becomes shorter than that of the solid image, since a smaller amount of ink is used. Moreover, since a smaller amount of ink is used, it is possible to prevent the medium from being curled. Upon the transport operation, the medium on which no image is printed is transported to the areas A to C and the thinned white images printed in the areas A to C upon the first print operation are transported to the areas D to F.

Like the first print operation, upon a second print operation, the printer 1 also prints the thinned white image in the areas A to C, and then prints the image ABC in the areas D to F. In this case, in the second print operation, the thinned white images printed in the first print operation are formed in the areas D to F. Upon the second print operation, the dots of the image ABC are formed in the pixels (that is, the pixels corresponding to the characters ABC) different from the pixels where the dots of the thinned white image are formed. In this way, upon the second print operation, the three printing products are completed in the areas D to F.

After the second print operation, the printing products are printed at the same interval on the medium by alternately repeating the same transport operation and the same print operation. In the print operation after the second print operation, the thinned white image is printed in the areas A to C and three printing products are completed in the areas D and F. In addition, in the print operation after the second print operation, the medium on which no image is printed is transported to the areas A to C, the thinned white images printed in the areas A to C in the immediately previous print operation are transported to the areas D to F.

According to the fourth embodiment, three printing products are completed in every print operation.

If a solid white image is printed and the image ABC is printed on the solid white image, the amount of ink used upon printing the solid image may be increased, thereby causing the medium to be curled easily. Moreover, since it is difficult to dry the white image, the image ABC may spread upon printing the image ABC.

In this embodiment, however, the dots are not formed in the pixels where the dots of the image ABC are formed upon printing the white image. Accordingly, since the amount of ink used is smaller than the amount of ink used to print the solid image, it is possible to prevent the medium from being curled. Moreover, since it is easy to dry the white image, it is possible to prevent the image ABC from spreading.

### Modified Example

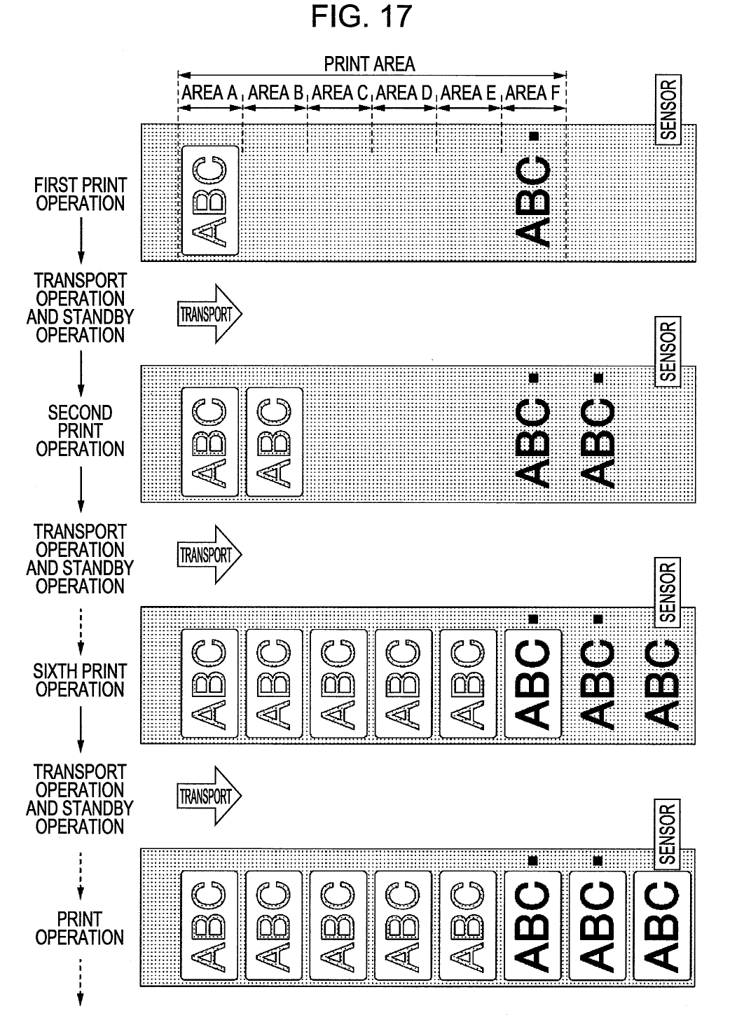

FIG. 17 is an explanatory diagram according to a modified example of the fourth embodiment. In this modified example, the printer repeats the print operation of printing the thinned white image in the area A and printing the image ABC in the area F and the transport operation of transporting the medium by a transport distance corresponding to the length of one printing product, as described below.

Upon a first print operation, the printer 1 first prints the thinned white image in the area A and prints the image ABC in the area F on the downstream side of the area A in the transport direction, while moving the head 31 in the movement direction. In this case, no image is printed in the areas B to E. Upon the first print operation, a mark is printed in the area F.

After the first print operation, the printer 1 transports the medium by the transport distance corresponding to the length of one printing product (the transport operation). Upon the transport operation, the medium on which no image is printed is transported to the area A and the thinned white image printed in the area A in the first print operation is transported to the area B.

Like the first print operation, upon a second print operation, the printer 1 also prints the thinned white image in the area A, and then prints the image ABC in the area F. In this case, no image is printed in the areas B to E. After the second print operation, the printer 1 alternately repeats the same transport operation and the same print operation.

Like the first print operation, upon a sixth print operation, the printer 1 prints the thinned white image in the area A and prints the image ABC in the area F. In this case, in the sixth print operation, the thinned white image printed in the first print operation is formed in the area F. Accordingly, upon the sixth print operation, one printing product is completed in the area F.

In this modified example, one printing product is completed in every print operation.

In this modified example, since one printing product is printed in every print operation, a print speed may be slower than that of the first embodiment. In this modified example, however, since the period in which the white image is printed and then the image ABC is printed becomes long, the image ABC can be printed after the thinned white image is sufficiently dried on the hot platen 41. That is, it is possible to reliably prevent the medium from being curled and prevent the image ABC from spreading.

The transport distance of the transport operation according to this modified example is shorter than the transport distance of the transport operation according to the fourth embodiment. Accordingly, in this modified example, since the drying mechanism 42 can just heat the medium in the range corresponding to one area (for example, the area A), power consumption can be reduced.

### Fifth Embodiment

### Printing Product According to Fifth Embodiment

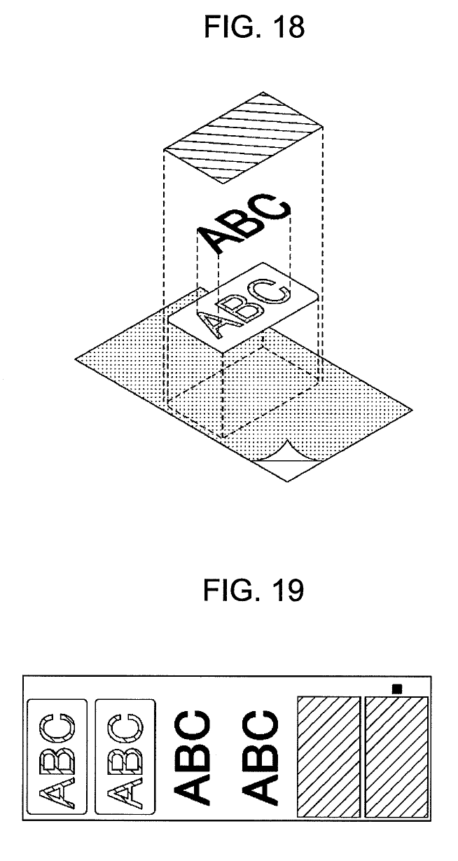

FIG. 18 is an explanatory diagram illustrating a printing product according to a fifth embodiment. The number of images (the number of layers) printed on a medium is different from that of the printing product according to the fourth embodiment.

The medium is constituted by a seal member in which one side is a printing surface and the other side is an adhesive surface and a peeling member covering the adhesive surface of the seal member. The seal member is formed of a transparent film. In this case, the seal member is not necessarily transparent but may be translucent or opaque. The medium may not be a seal sheet, but may be a transparent film having no adhesive surface, or a sheet.

A printing product is obtained by printing three images on the medium in an overlapping manner. An image initially printed on the medium is a thinned white image. An image printed on the thinned white image is an image ABC. An image printed on the image ABC is a rectangular image formed by applying a coating agent (hereinafter, referred to as “a coating image”). In other words, the printing product is obtained by printing a first-layered thinned white image, a second-layered image ABC, and a third-layered coating image on the medium in the overlapping manner.

As in the fourth embodiment, the thinned white image and the image ABC stand in a complementary relation. That is, the dots of the image ABC are formed in the pixels where the dots of the thinned white image are not formed.

The coating agent has the function of improving a glossy property or the function of improving a water-resistant property. That is, by forming this coating agent as the third layer, it is possible to improve the glossy property of the white image or the image ABC or improve the water-resistant property of the printing product. Alternatively, a coating agent having another function may be used.

### Image data Generating Method According to Fifth Embodiment

FIG. 19 is an explanatory diagram illustrating image data used to perform the print operation according to the fifth embodiment. As shown in the drawing, the image data contains two thinned white image to be printed in the areas A and B, two images ABC to be printed in the areas C and D, and two coating images to be printed in the areas E and F. The image data also contains a mark used to print an image in the area F.

In the fifth embodiment, the CPU 62 of the printer 1 divides a printing target image in accordance with each color pattern, as in the fourth embodiment. In the fifth embodiment, the printing target image is an image surrounding the characters ABC in a white background. That is, the printing target image has a white color (the background) and a color (the characters ABC) other than a white color. Accordingly, the CPU 62 divides the printing target image into an image (the thinned white image) of the white background and an image (the image ABC) of the characters ABC. Moreover, the CPU 62 generates the image data in which the images are arranged as in FIG. 19 and stores the image data in the memory 63.

### Printing Method According to Fifth Embodiment

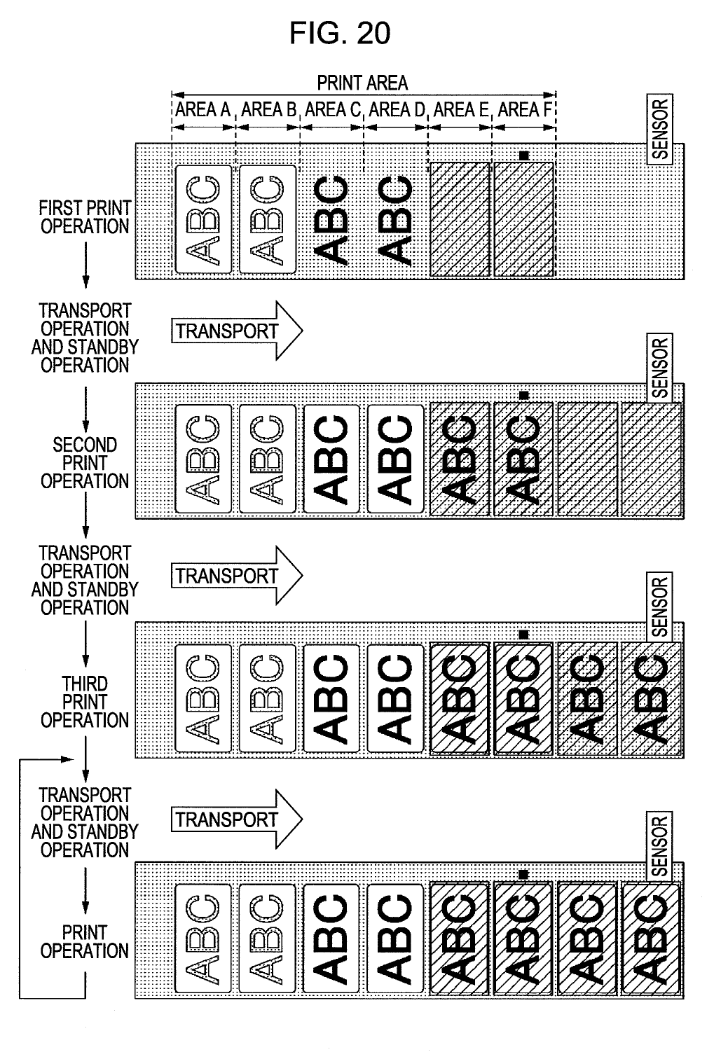

FIG. 20 is an explanatory diagram illustrating a printing method according to the fifth embodiment. In the fifth embodiment, as described below, the printer 1 repeats the print operation performed on the basis of the image data in FIG. 19 and the transport operation of transporting the medium by a transport distance corresponding to the length of two printing products.

First, upon a first print operation, the printer 1 prints the thinned white images in the area A and B, respectively, prints the images ABC in each of the areas C and D on the downstream side of the areas A and B in the transport direction, respectively, and prints the coating images in the areas E and F on the downstream side of the areas C and D in the transport direction, respectively, while moving the head 31 in the movement direction. Upon the first print operation, the mark is printed in the area F.

After the first print operation, the printer 1 transports the medium by the transport distance corresponding to the length of two printing products (the transport operation). When the medium is transported upon the first print operation described above until a sensor detects the mark printed in the area F, the transport operation is performed by the transport distance corresponding to the length of the two printing products. During the transport operation, a standby operation of drying the thinned white images or the images ABC is also performed. Upon the transport operation, the medium on which no image is printed is transported to the areas A and B, the thinned white images printed in the areas A and B upon the first print operation are transported to the areas C and D, and the images ABC printed in the areas C and D upon the first print operation are transported to the areas E and F.

Like the first print operation, upon a second print operation, the printer 1 also prints the thinned white image in the areas A and B, respectively, prints the images ABC in the areas C and D, respectively, and then prints the coating images in the areas E and F respectively. In this case, in the second print operation, the thinned white images printed in the first print operation are formed in the areas C and D and the images ABC printed upon the first print operation are formed in the areas E and F. Accordingly, upon the second print operation, the images ABC are printed on the thinned white image in the areas C and D, respectively, and the coating images are printed on the images ABC in the areas E and F, respectively.

After the second print operation, the printer 1 transports the medium by the transport distance corresponding to the length of two printing products (the transport operation). In the transport operation, the medium on which no image is printed is transported in the areas A and B, the thinned white images printed in the areas A and B in the second print operation are transported to the areas C and D, and the images ABC printed on the thinned white images in the areas C and D in the second print operation are transported to the areas E and F.

Like the first and second print operations, upon a third print operation, the printer 1 also prints the thinned white images in the areas A and B, respectively, the images ABC in the areas C and D, respectively, and prints the coating images in the areas E and F, respectively. In this case, in the third print operation, the thinned white images are formed in the areas C and D and the images ABC printed on the thinned white images are formed in the areas E and F. Accordingly, in the third print operation, the images ABC are printed on the thinned white images in the areas C and D and the two printing products are completed in the areas E and F.

After the third print operation, the printing products are printed at the same interval on the medium by alternately repeating the same transport operation and the same print operation. In the print operation after the third print operation, the thinned white images are printed in the areas A and B, respectively, the dots of the images ABC are formed in the pixels where the dots of the thinned white images are not formed in the areas C and D, and the two printing products are completed in the areas E and F. In addition, in the print operation after the third print operation, the medium on which no image is printed is transported to the areas A and B, the thinned white images printed in the areas A and B are transported to the areas C and D immediately before the print operation, and the images ABC printed on the thinned white images in the areas C and D are transported to the areas E and F.

According to the fifth embodiment, two printing products are completed in every print operation.

According to the fifth embodiment, another printing product can be printed, while obtaining the same advantages as those of the fourth embodiment.

### First Modified Example

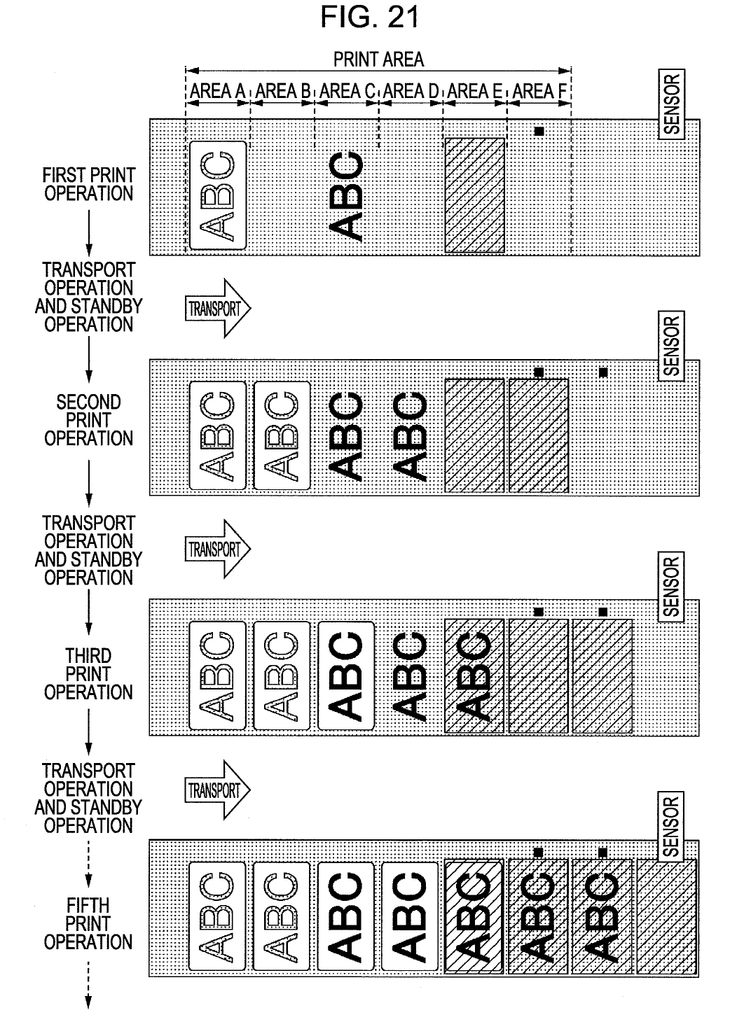

FIG. 21 is an explanatory diagram according to a first modified example of the fifth embodiment. In this modified example, the printer repeats the print operation of printing the thinned white image in the areas A, printing the image ABC in the areas C, and printing the coating image in the area E and the transport operation of transporting the medium by a transport distance corresponding to the length of one printing product, as described below.

Upon a first print operation, the printer 1 first prints the thinned white image in the area A, prints the image ABC in the area C on the downstream side of the area A in the transport direction, and prints the coating image in the area E on the downstream side of the area C in the transport direction, while moving the head 31 in the movement direction. In this case, no image is printed in the areas B, D, and F. Upon the first print operation, a mark is printed in the area F.

After the first print operation, the printer 1 transports the medium by the transport distance corresponding to the length of one printing product (the transport operation). Upon the transport operation, the medium on which no image is printed is transported to the area A, the thinned white image printed in the area A in the first print operation is transported to the area B, the image ABC printed in the area C in the first print operation is transported to the area D, and the coating image printed in the area E in the first print operation is transported to the area F.

Like the first print operation, upon a second print operation, the printer 1 also prints the thinned white image in the area A, prints the image ABC in the area C, and prints the coating image in the area E. In this case, no image is printed in the areas B, D, and F. After the second print operation, the printer 1 alternately repeats the same transport operation and the same print operation.

Like the first print operation, upon a print operation after a fifth print operation, the printer 1 prints the thinned white image in the area A, prints the image ABC in the area C, and prints the coating image in the area E. In this case, in the print operation after the fifth print operation, the thinned white image is formed in the area E and the image ABC printed on the thinned white image is formed in the area E. Accordingly, upon the print operation after the fifth print operation, the image ABC is printed on the thinned white image in the area C and one printing product is completed in the area E.

In this modified example, one printing product is completed in every print operation.

In this modified example, since one printing product is printed in every print operation, a print speed may be slower than that of the fifth embodiment. In this modified example, however, since the period in which the thinned white image is printed and then the image ABC is printed becomes long, the image ABC can be printed after the thinned white image is sufficiently dried on the hot platen 41. In this modified example, since a period of which the image ABC is printed and then the coating image is printed becomes long, the coating image can be printed after the image ABC is sufficiently dried on the hot platen 41. Accordingly, it is possible to improve the quality of the printing product.

The transport distance of the transport operation according to this modified example is shorter than the transport distance of the transport operation according to the fifth embodiment. Accordingly, in this modified example, since the drying mechanism 42 can just heat the medium in the range corresponding to one area (for example, the area A), power consumption can be reduced.

### Second Modified Example

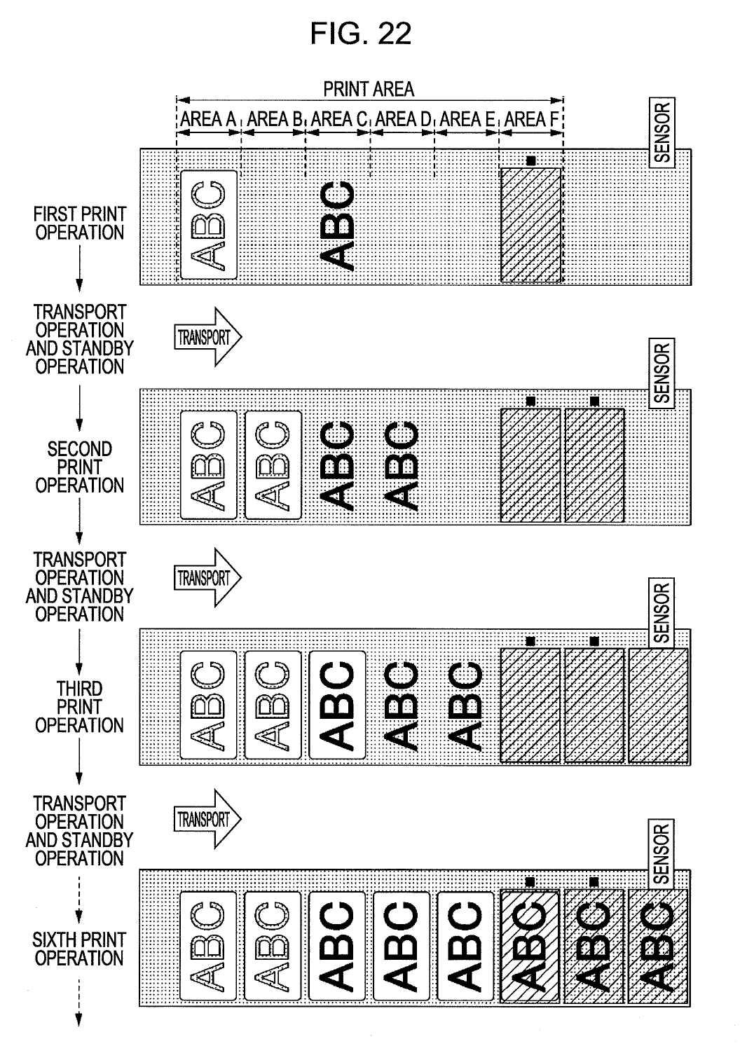

FIG. 22 is an explanatory diagram according to a second modified example of the fifth embodiment. In the second modified example, an area where the coating image is printed is different from that of the first modified example.

In the second modified example, the area where the coating image is printed is the area F. That is, the area where the coating image is printed is an area on the downstream side of the area of the first modified example in the transport direction. As a consequence, in the second modified example, the period in which the image ABC is printed and then the coating image is printed becomes longer than the period of the first modified example. Therefore, the coating image can be printed after the image ABC is sufficiently dried on the hot platen 41.

When it takes much time to dry the thinned white image, the image ABC may be arranged in the area (for example, the area D) on the downstream side in the transport direction in FIG. 22. By doing so, the period in which the thinned white image is printed and then the image ABC is printed become longer. Therefore, the image ABC can be printed after the thinned white image is sufficiently dried on the hot platen 41. In this way, by arranging the images of the image data in accordance with the drying period of the images to be printed, it is possible to prevent the image from spreading.

### Sixth Embodiment

### Printing Product According to Sixth Embodiment

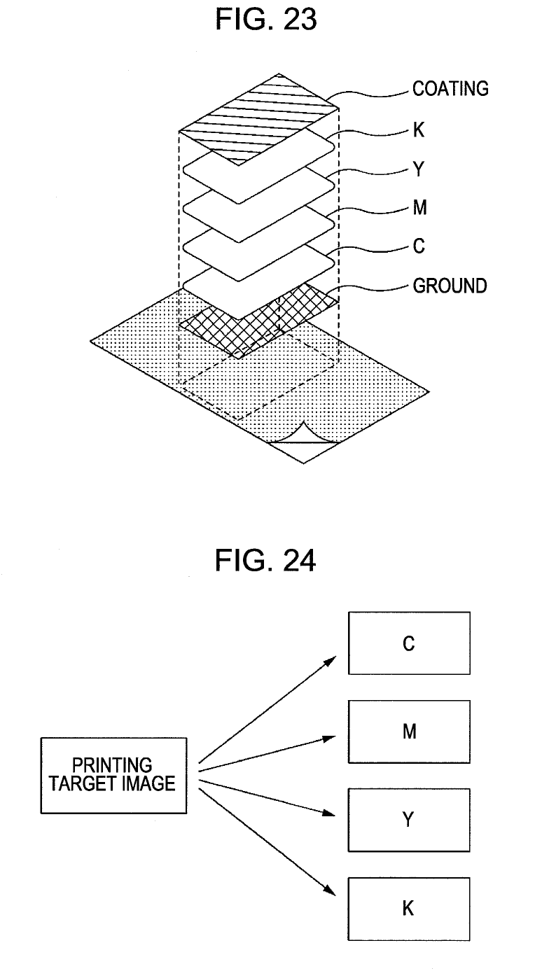

FIG. 23 is an explanatory diagram illustrating a printing product according to a sixth embodiment.

The medium is constituted by a seal member in which one side is a printing surface and the other side is an adhesive surface and a peeling member covering the adhesive surface of the seal member. The seal member is formed of a transparent film. In this case, the seal member is not necessarily transparent but may be translucent or opaque. The medium may not be a seal sheet, but may be a transparent film having no adhesive surface, or a sheet.

A printing product is obtained by printing six images on the medium in an overlapping manner. An image initially printed on the medium is a rectangular image (hereinafter, referred to as “a ground image”) formed by applying a fixative. An image printed on the ground image is an image (hereinafter, referred to as a cyan image) for forming dots of cyan (C) ink of a printing target image. An image printed on the cyan image is an image (hereinafter, referred to as a magenta image) for forming dots of magenta (M) ink of the printing target image. An image printed on the magenta image is an image (hereinafter, referred to as a yellow image) for forming dots of yellow (Y) ink of the printing target image. An image printed on the yellow image is an image (hereinafter, referred to as a black image) for forming dots of black (K) ink of the printing target image. An image printed on the black image is a coating image. In other words, the printing product is obtained by overlapping a first-layered ground image, a second-layered cyan image, a third-layered magenta image, a fourth-layered yellow image, a fifth-layered black image, and a sixth-layered coating image on the medium.

The fixative has a function of accelerating ink absorption. By printing the ground image on the medium by the use of the fixative, an image (here, an image ABC) can be easily printed on a medium which does not usually absorb ink. Alternatively, a fixative having another function may be used.

### Image data Generating Method According to Sixth Embodiment

FIG. 24 is an explanatory diagram according to the sixth embodiment. In the sixth embodiment, the CPU 62 of the printer 1 generates an image of each color ink (other than a white color) on the basis of the printing target image. In this embodiment, the cyan image, the magenta image, the yellow image, and the black image are generated on the basis of the printing target image. Moreover, the CPU 62 generates the image data in which the images are appropriately arranged.

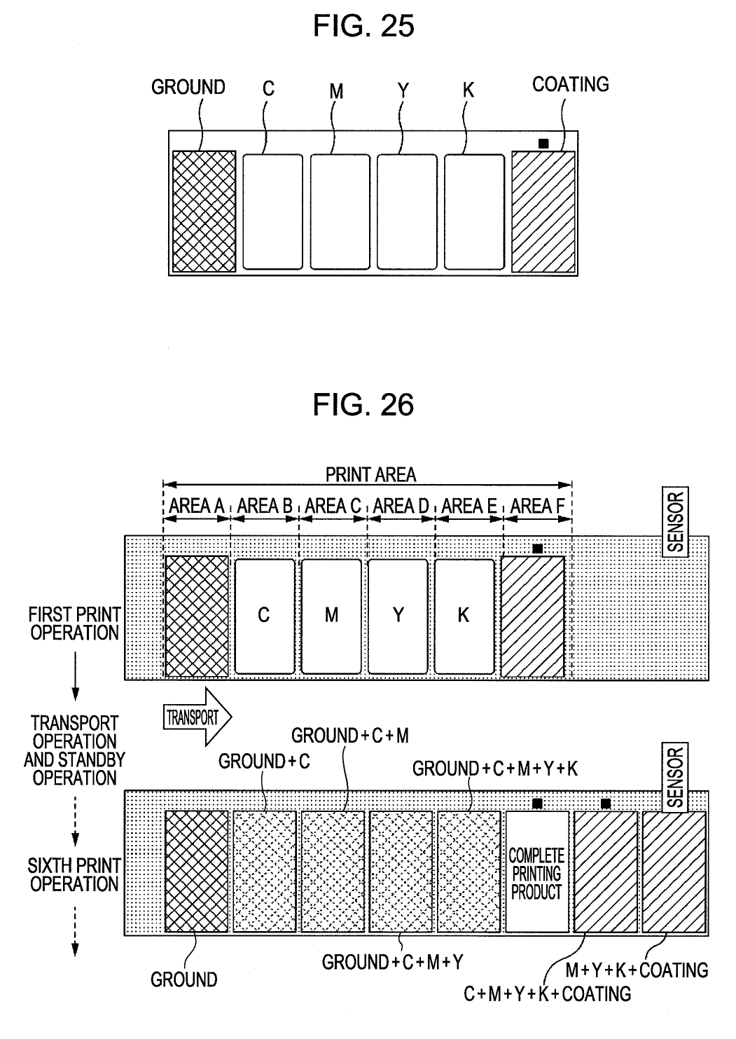

FIG. 25 is an explanatory diagram illustrating the image data used to perform the printing operation according to the sixth embodiment. As shown in the drawing, the image data contains the ground image to be printed in the area A, the cyan image to be printed in the area B, the magenta image to be printed in the area C, the yellow image to be printed in the area D, the black image to be printed in the area E, and the coating image to be printed in the area F. The image data also contains a mark used to print an image in the area F. The image data is stored in the memory 63.

### Printing Method According to Sixth Embodiment

FIG. 26 is an explanatory diagram illustrating a printing method according to the sixth embodiment.

Upon a first print operation, the printer 1 first prints the ground image in the area A, prints the cyan image in the area B, prints the magenta image in the area C, prints the yellow image in the area D, prints the black image in the area E, and prints the coating image in the area F, while moving the head 31 in the movement direction. Upon the first print operation, a mark is printed in the area F.

After the first print operation, the printer 1 transports the medium by a transport distance corresponding to the length of one printing product (the transport operation). During the transport operation, a standby operation of drying the respective images is also performed. Upon the transport operation, the medium on which no image is printed is transported to the area A, the cyan image, the magenta image, the yellow image, and the black image printed in the areas B to E, respectively, in the first print operation are transported to the area beside the downstream side in the transport direction, and the coating image printed in the area F in the first print operation is transported outside the print area.

After the first transport operation, the printer 1 alternately repeats the print operation of printing the images in the areas, respectively, on the basis of the image data and the transport operation of transporting the medium by the transport distance corresponding to the length of one printing product.

In a sixth print operation, the printer 1 also prints the ground image in the area A, prints the cyan image in the area B, prints the magenta image in the area C, prints the yellow image in the area D, prints the black image in the area E, and prints the coating image in the area F, while moving the head 31 in the movement direction. In this case, in the sixth print operation, the ground image is formed in the area B, the cyan image printed on the ground image is formed in the area C, and the magenta image printed on the ground image and the cyan image is formed in the area D. The yellow image printed on the ground image, the cyan image, and the magenta image is formed in the area E. The black image printed on the ground image, the cyan image, the magenta image, and the yellow image is formed in the area F. Accordingly, in the sixth print operation, the ground image is printed in the area A, the cyan image is printed on the ground image in the area B, and the magenta image is printed on the cyan image in the area C. The yellow image is printed on the magenta image in the area D, the black image is printed on the yellow image in the area E, and then one printing product is completed in the area F.

According to the sixth embodiment, one printing product is completed in every print operation.

In the sixth embodiment, the printing product is manufactured by alternately repeating the print operation performed on the basis of the image data in FIG. 25 and the transport operation of transporting the medium by the transport distance corresponding to the length of one printing product.

If the printing target image is printed in the area B, for example, at one time, a considerable amount of ink may be used. Therefore, the medium may be curled or the images may spread.

In this embodiment, however, the images printed in the areas, respectively, are divided in accordance with respective ink colors. Moreover, the printing target image is formed by printing the images in the overlapping manner. In this way, since the amount of ink used to print each image can be reduced more than the amount of ink used to print the printing target image at one time, it is possible to prevent the medium from being curled or prevent the image from spreading. Accordingly, it is possible to improve the quality of the printing product.

In this embodiment, the printing target image, which is a color image used for visibility, is divided into the plurality of images in accordance with the ink colors. In addition, the plurality of images generated from the printing target image is the images formed by different kinds of liquids (ink) used in the print operation. The plural kinds of ink used to print the printing target image may be divided into at least two ink groups to form respective images. Each of the formed images may be an image to be printed using two or more kinds of ink. Alternatively, each image may be an image formed by using ink other than YMCK ink. Two or more images generated from the printing target image may be images in which the pixel positions for forming dots are different from each other, or images in which the pixel positions are the same. The ground image or the coating image may not be used.

### Other Embodiments

In the above-described embodiments, the printer has mainly been described, but of course, there is included the description of a printing apparatus, a recording apparatus, a liquid ejecting apparatus, a printing method, a recording method, a liquid ejecting method, a printing system, a recording system, a computer system, a program, a recording medium for storing programs, a printing product manufacturing method, and the like.

The printer has been described according to the embodiments. However, the description of the above-described embodiments is made for easy understanding of the invention and does not limit the invention. Of course, the invention may be modified and improved without departing from the gist of the invention and includes the equivalents of the invention. In particular, in the following embodiments, the modification, the improvement, and the equivalents of the invention are included in the invention.

### <Regarding Printing Apparatus>

In the above-described embodiments, the image data is stored in the memory 63 of the printer 1. However, the memory 63 of the printer 1 may not store the image data. For example, a memory (not shown) of the external computer 110 may store the image data.

### <Regarding Printer>

The printer 1 according to the above-described embodiments can perform printing by a one-time print operation on the entire surface of the print area by scanning the carriage once in the transport direction. However, this technique is not limited to this printer. For example, upon performing the print operation on the entire surface of the print area, a printer may be used which performs a one-time print operation by scanning the carriage several times or a printer may be used which performs a one-time print operation by scanning the carriage in a direction intersecting the transport direction once or several times. Alternatively, a printer may be used which performs a one-time print operation on the print area by moving the carriage to the print area in a two-dimensional manner. In such a printer, it takes more time to perform the print operation, compared to the above-described printers. However, the size of a head can be reduced, for example.

### <Regarding Image>

In the above-described embodiments, the image ABC, the mirror image ABC, the image XYZ, and the like are printed. The image to be printed is not limited to a character image, but may be a figure image or a photo image.

In the above-described embodiments, the white images are printed as the ground image for easily viewing the image ABC and the like. However, the ground image is not limited to the white image (white color), but may be a different colored image. When the image ABC is printed on a transparent medium, the image ABC is readily viewed due to the ground image. Moreover, by making the ground image thicker, the image ABC is more readily viewed.

In the above-described embodiments, a base image such as a background image, a ground image, a coating image has a rectangular shape, but the invention is not limited to the rectangular shape. For example, the base image may have the same shape of that of the characters ABC so as to match with the image ABC or may have a shape surrounding the frame of the characters ABC.

In the above-described embodiments, the ground image or the coating image have been formed to perform a process of improving the absorptive property of ink, the glossy property, and the water-resistant property. A processing image for performing the process is not limited to the above-described ground image or coating image. For example, the processing image may be an adhesive layer image for forming an adhesive layer or a hiding image for forming a hiding layer of a scratch card (a card used to show an image when the silver-colored hiding layer is scratched with a coin).

### <Regarding Printing Product>

As a use example of the printing product in which the mirror image ABC and the image XYZ are printed, the printing product is attached onto a window. However, the invention is not limited thereto. For example, the printing product may be used as a tag. When the printing product is assumed to be used as a tag, it is not necessary to form the adhesive surface such as a seal sheet in a medium.

### <Regarding Drying Mechanism>

In the above-described embodiments, the heating range of the drying mechanism 42 can be changed by the controller 60. However, when two printing products are completed by a one-time print operation, the drying mechanism 42 (for example, the drying mechanism 42 heating the heating range corresponding to two areas) heating a smaller heating range may be prepared. Then, a space can be saved and the cost can be reduced. Alternatively, the drying mechanism may not be used.

### <Regarding Printing Medium>

In the above-described embodiments, the print operation is performed on the printing medium such as a film, but the printing medium is not limited to a film. An ink absorbing property of a film is low. Therefore, when the subsequent image is printed in a state where the ink of an image is not sufficiently absorbed, the image easily spreads. Accordingly, the advantages of the invention are particularly achieved. Even when a printing medium such as a normal sheet which is easily curled is used, the advantages of the invention are particularly achieved. However, the invention is not limited to this printing medium. Printing mediums different from this medium may be used. It is also possible to prevent the printing mediums from being curled or prevent the image from spreading.

1. A printing product manufacturing method of printing a plurality of printing products on a medium, comprising:
generating first and second images on the basis of a printing target image;
printing the first image in a first area of a print area and printing the second image in a second area of the print area on the downstream side of the first area in a transport direction; and
transporting the first image printed in the first area to the second area,
wherein the printing products in which the printing target image is printed on the medium are manufactured by alternately repeating the printing and the transporting.

2. The printing product manufacturing method according to claim 1, wherein the first image and the second image are different from each other.

3. The printing product manufacturing method according to claim 1,
wherein the first image is an image used to form dots in certain pixels of the printing target image, and
wherein the second image is an image used to form dots in another pixels of the printing target image.

4. The printing product manufacturing method according to claim 1,
wherein the first image is an image used to form dots of a certain color of the printing target image, and
wherein the second image is an image used to form dots of another color of the printing target image.

5. The printing product manufacturing method according to claim 1,
wherein the printing target image is a background image, and
wherein an image used to view the background image as a background and the printing target image are printed in an overlapping manner.

6. The printing product manufacturing method according to claim 1,
wherein one of the first image and the second image is a background image, and
wherein the other of the first image and the second image is an image used to view the background image as a background.

7. The printing product manufacturing method according to claim 5, wherein when the image used to view the background image as the background is printed in a third area different from the first and second areas upon printing the first image in the first area and upon printing the second image in the second area, a gap between the first and second areas is narrower than a narrower one of a gap between the first and third areas and a gap between the second and third areas.

8. The printing product manufacturing method according to claim 1,
wherein in certain transporting, the first image is transported from the first area to an area between the first and second areas, and
wherein in the subsequent transporting, the first image is transported from the area between the first and second areas to the second area.

9. A printing product manufacturing apparatus which prints a plurality of printing products on a medium, comprising:
a unit which generates first and second images on the basis of a printing target image;
a unit which prints the first image in a first area of a print area and prints the second image in a second area of the print area on the downstream side of the first area in a transport direction; and
a unit which transports the first image printed in the first area to the second area,
wherein the printing products in which the printing target image is printed on the medium are manufactured by alternately repeating the printing and the transporting.

10. A printing product printing method of printing a plurality of printing products on a medium, comprising:
generating first and second images on the basis of a printing target image;
printing the first image in a first area of a print area and printing the second image in a second area of the print area on the downstream side of the first area in a transport direction; and
transporting the first image printed in the first area to the second area,
wherein the printing products in which the printing target image is printed on the medium are manufactured by alternately repeating the printing and the transporting.
